(19) United States
(12) Patent Application Publication
(10) Pub. No.: US 2013/0212460 A1
(43) Pub. Date: Aug. 15, 2013

(54) TRACKING VISIBILITY OF RENDERED OBJECTS IN A DISPLAY AREA

(71) Applicant: Viswanathan Balasubramanian, Issaquah, WA (US)

(72) Inventor: Viswanathan Balasubramanian, Issaquah, WA (US)

(73) Assignee: MICROSOFT CORPORATION, Redmond, WA (US)

(21) Appl. No.: 13/371,463

(22) Filed: Feb. 12, 2012

(51) Int. Cl. G06F 17/00

(52) U.S. Cl. 715/234

(57) ABSTRACT

When rendering a page for display, objects in the page are marked as visible, partially visible, or visible, based on the size and position of each object and the position and size of the page in the display area. This information is tracked as the impression data and can be used to provide better recommendations, advertising revenue and pricing information, and other business uses. In the end, business intelligence based on impressions and click-throughs can be based on what a user actually saw, not just what was rendered.

### BACKGROUND

When an object, such as a page from a web site, is displayed on a client computer, such as in a web browser, the fact that the object is displayed typically is tracked and sent to a server computer which provided the object. Whether an object is displayed typically is called an “impression.” If a user manipulates that object, such as by performing a gesture through a user interface that activates a hyperlink associated with that object, the manipulation also is tracked. Whether an object is manipulated typically is called a “click-through.”

Page impressions and click through data commonly is tracked and stored by server computers. This information in turn is used for a variety of business purposes, such as for determining advertising revenue and pricing, recommending content, and the like.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

One weakness of current implementations that track impressions is the assumption that if a page is rendered for a display, such as in a web browser, all of its contents are viewed by the user. However, often the actual display area is smaller than the rendered page, and less than all its contents are visible.

When rendering a page for display, objects on the page are marked as visible, partially visible, or visible, based on the size and position of the object and the size and position of page in the display area. Sub objects of each object can be similarly processed. This information is tracked as the impression data and can be used to provide better recommendations, advertising revenue and pricing information, and other business uses. In the end, business intelligence based on impressions and click-throughs can be based on what a user actually saw, not just what was rendered.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of a computer system in which the visibility of objects is tracked.

FIG. 2 is a diagram explaining visibility of rendered data in a display.

FIG. 3 is a flow chart describing an example implementation of rendering by an application in FIG. 1.

FIG. 4 is a flow chart describing an example implementation of an application in FIG. 1.

FIG. 5 is a flow chart describing an example implementation of a business intelligence engine in FIG. 1.

FIG. 6 is a block diagram of an example computing device with which components of such a system can be implemented.

### DETAILED DESCRIPTION

The following section provides an example operating environment in which visibility tracking of objects can be implemented.

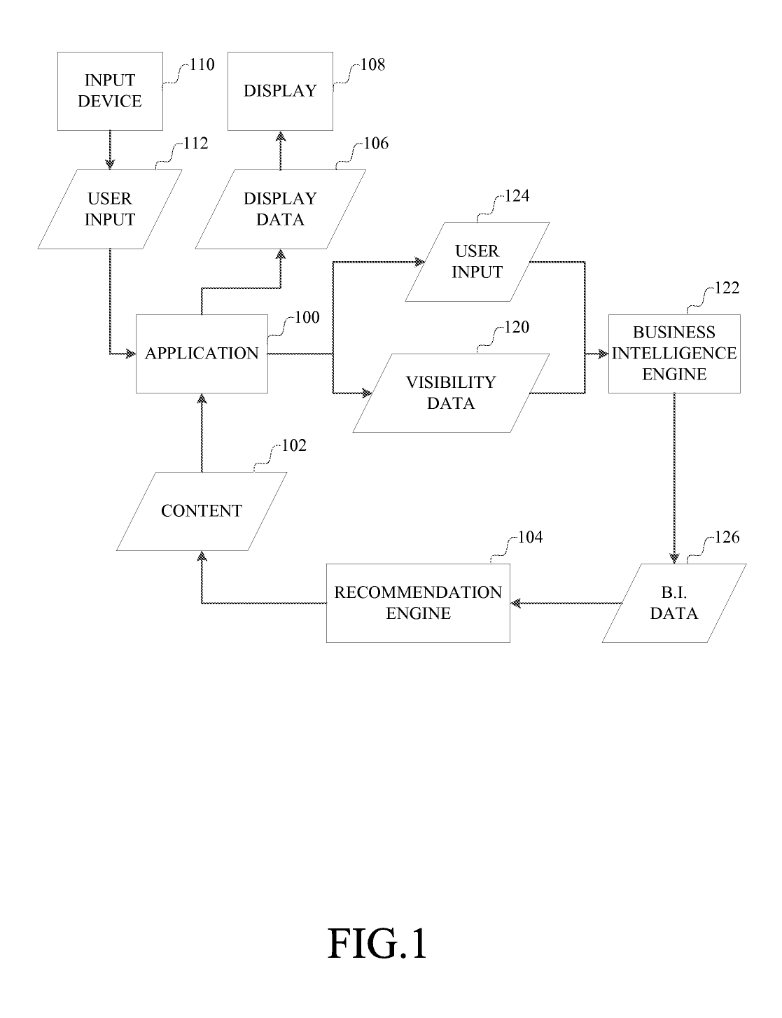

Referring to FIG. 1, an application 100 receives content 102 from a recommendation engine 104. The application 100 can be a browser application. The application 100 typically is run on a client computer, whereas the recommendation engine 104 is run on one or more server computers. Such client computers and server computers are connected by and communicate over a computer network. In response to a request to one of the server computers from the application 100 on the client computer, the recommendation engine 104 provides the content 102 to the application 100, which in turn renders the content 102 into display data 106, which is presented to a user through a display 108. Through an input device 110, the user provides user input 112 to the application 100.

When the application 100 displays the content 102, it determines which portions of the content are visible, partially visible and not visible in the display 108, and provides information 120 about the visible objects to a business intelligence engine 122. The application also can provide information 124 about the user input, such as whether a displayed object had been manipulated, to the business intelligence engine.

The business intelligence engine 122 can be implemented using one or more server computers, which are connected to and communicate with the client computer for the application over a computer network. The business intelligence engine 122 can reside on different server computers or the same server computers as the recommendation engine 104.

The business intelligence engine 122 collects the data from the application 100 in the form of name and value pairs, including but not limited to data describing the user's screen resolution, objects rendered on the page, location of each object on the page, and visibility of each object. The collected data are processed using standard techniques to determine a visible impression for each object, which is stored in a database in the form of facts and dimensions. This data is tracked per-user over multiple users.

The data generated by the business intelligence engine is shared (as shown at 126) with the recommendation engine 104. The data 126 could be passed through memory, or over a computer network, depending on the implementation of the engines 122 and 104.

The recommendation engine 104 uses data 126 to recommend content. The content is recommended based on actual visible impressions seen by users with similar interests (as determined by collaborative filtering), thus providing higher quality, more meaningful recommendations for the user.

Collecting the visible property information provides an actual count of similar users actually viewing the content and interacting with the provided content 102. For example, the business intelligence engine can track which objects have been manipulated by the user in the past. This history of object manipulations can be used to infer interest in a topic, which can then be used to select content such as advertising, news stories and the like that might be of interest to the user.

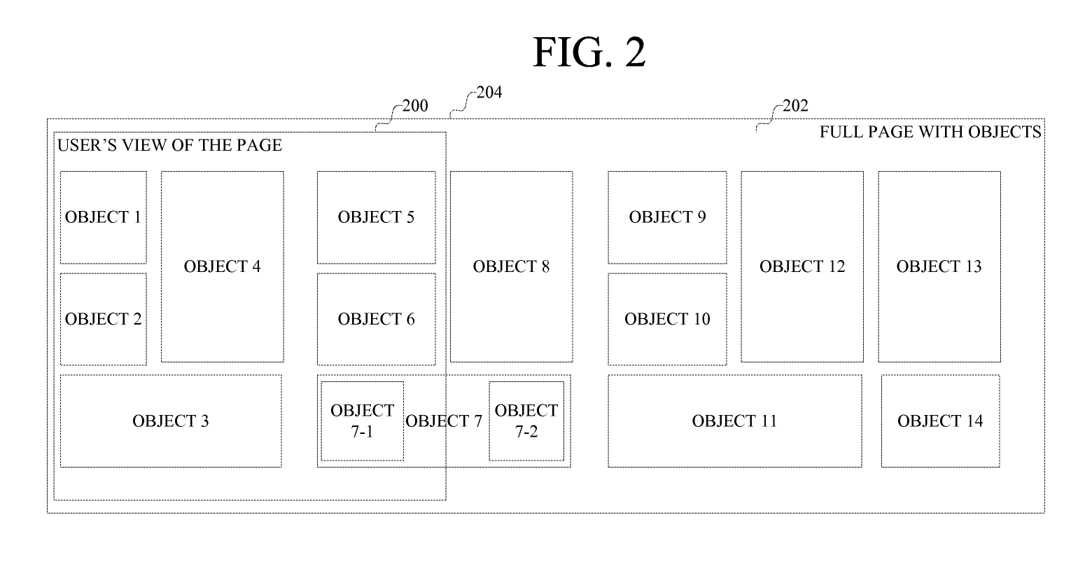

When tracking visibility information about objects displayed on the display, objects in general can be visible, partially visible or not visible, such as shown by way of example in FIG. 2. FIG. 2 illustrates a display area 200 which includes the user's view of a page 202. When the page is rendered, such as in memory, the actual image (in this example) has a size shown by the box 204. In this example, objects 1 through 6 are visible in display area 200, while object 7 is only partially visible. Objects 8 through 14 are not visible. An object also may have subobjects. For example, in Object 7, there are subobjects 7-1 and 7-2. Subobject 7-1 is visible; subobject 7-2 is not. When information is reported back from the application to the business intelligence engine, it does not merely report that page 202 has been viewed. It also indicates that objects 1-6 are visible, object 7 is partially visible and subobject 7-1 is visible.

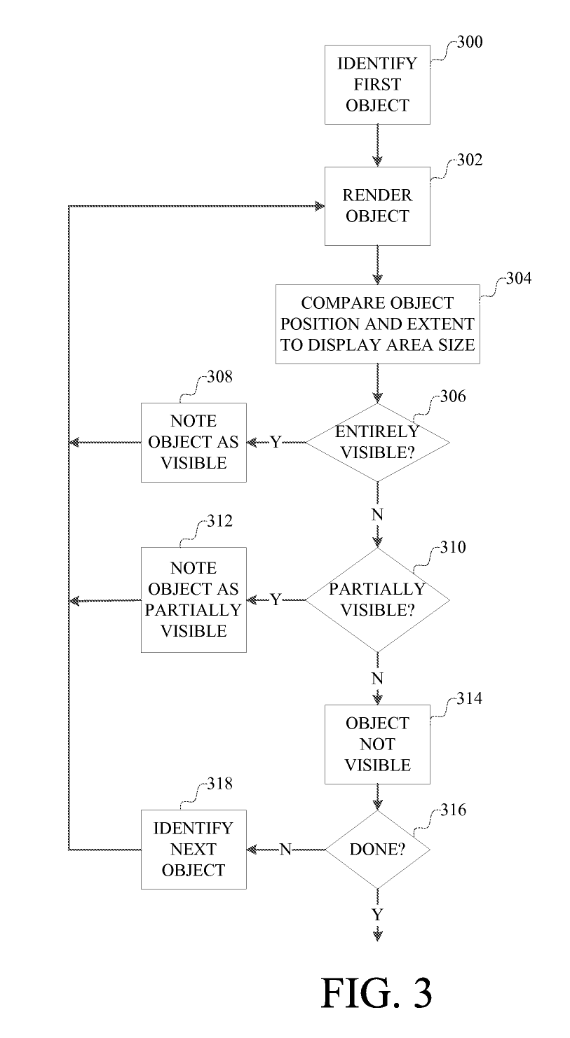

Given this context, an example implementation will be described in more detail in connection with FIGS. 3-5.

FIG. 3 is a flow chart describing how a page is rendered so as to identify visibility of objects.

A page typically is defined in a markup language such as XML, HTML or the like, and can identify one or more objects. Since the page is so defined, and in fact can be defined in the form of a template defining a structure in which content can be customized on demand for a user, the size and position of each object can be known in advance of rendering the page, and/or can be specified within the page itself. An object can be rendered using a control that is accessed by the application, such as an AJAX control implemented on the AJAX framework.

In one implementation using an AJAX control, when the AJAX control renders an object, it fires an event to determine the visibility of the object. This event provides, for example, an object identifier, an identifier (such as a uniform resource locator (URL)) of the page, and a title of the object. This data helps to easily identify the object content when content refreshes.

As an example implementation, the control can fire an explicit visible view event with object properties, such as:

FirePageViewEvent: function (biDataObject, targetUrl, title)
{
}

In addition to this call that obtains the objects visibility information, the additional system variables such as operating system and browser information can be collected as a part of an instrumentation script, while an SKU, screen resolution, page identifier, all object identifiers, including non-visible ones, can be collected by an event call. An example instrumentation call that provides object properties is the following:

LogCustomBiEvent: function (biDataObject, element)
{
}

The process of rendering a page starts with identifying 300 a first object from the page. The object is rendered 302. The object position and extent is compared 304 to the size of the display area. If the object is entirely visible in the display area, as determined at 306, then the object is noted as visible 308. For example, if the corners of a bounding box containing the object are within the display area, then the object is considered entirely visible. If the object is partially visible in the display area, as determined at 310, then the object is noted as partially 312. For example, if one of the corners of a bounding box containing the object is within the display area, but another of the corners of the bounding box is not within the display area, then the object is partially visible in the display area. Otherwise, the object is considered not visible. While an object can be marked as not visible, such marking is unnecessary as the lack of a visibility designation allows it to be inferred that the object is not visible. If all of the objects on the page have been processed, as determined at 316, then the process is complete, otherwise, the next object can be identified (318) and the process (302-316) can be repeated for the next object.

If an object has subobjects, the process of FIG. 3 can be repeated for each subobject of an identified object, by repeating steps 302-314 for each subobject, and so on recursively for its subobjects as well.

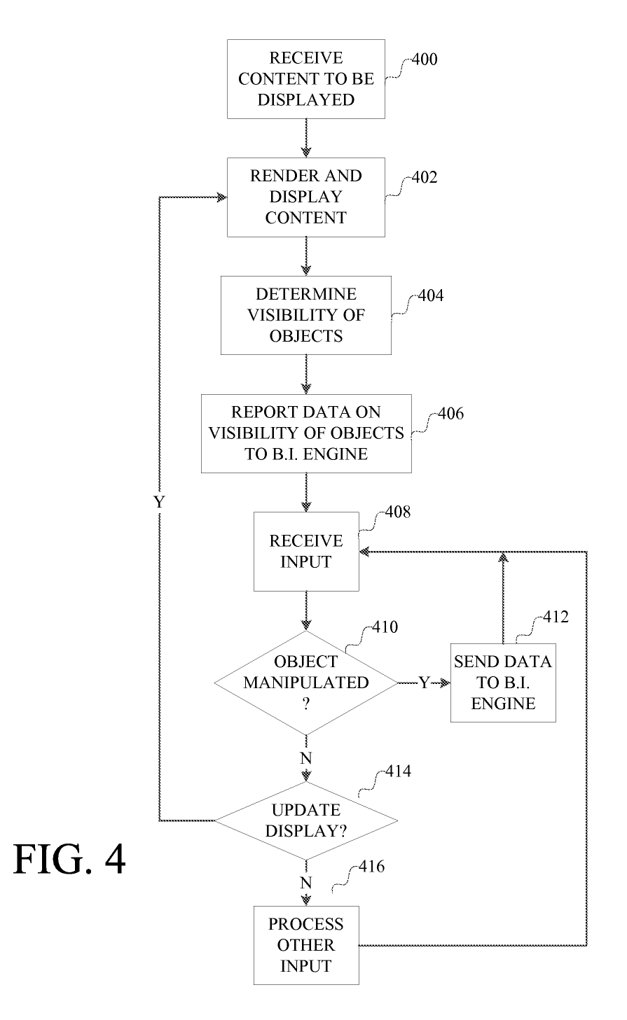

FIG. 4 is a flow chart describing an example implementation of an application in FIG. 1.

The application receives 400 content from the recommendation engine. The content is rendered and displayed 402, such as described above in connection with FIG. 3. From such rendering, the visibility of the objects in the content is determined 404, which in turn can be reported 406 to the business intelligence engine. In one implementation, a data collection script sends the visibility information of objects and users environment settings in name and value pairs to the business intelligence engine. The application also can use controls implemented using the AJAX framework to provide for the communication with the business intelligence engine. When the application receives 408 input from the user, such input is processed so as to manipulate an object, update the display, access other content, or the like. The processing of such inputs can result in a variety of information being provided from the application to the business intelligence engine. For example, if the input is for manipulating an object that is displayed, as determined at 410, information about such manipulation can be sent 412 to the business intelligence engine. If the input is for updating the display, as determined at 414, then the updated content is rendered (if the content is changed) and the display is updated by returning to step 402. For example, the input can be a gesture, resulting in a scroll, snap, drag or other user interface event intended to cause another part of the page to be displayed. When the page is updated 414, its visibility information also is updated and reported (404, 406). Other user inputs that neither update the display nor manipulate an object are processed (416), and further user input continues to be received 408 and processed accordingly.

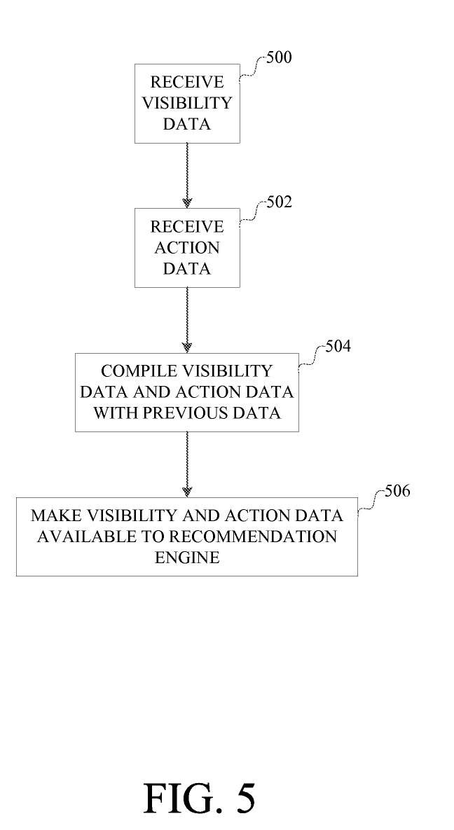

FIG. 5 is a flow chart describing an example implementation of a business intelligence engine in FIG. 1

The business intelligence engine periodically receives 500 the visibility data of objects from a page currently displayed in a display area to a user by the application. The visibility data also may include, or may be followed by, action data related to the displayed objects. Such information also is received 502 by the business intelligence engine. The visibility and action data are compiled and stored 504 in a database for analysis, along with data for the page as previously displayed to the user. The compiled data thus describe the visibility of the objects from the page as displayed to the user over time. In one implementation, the data are stored in the form of facts and dimensions. The compiled data are provided to or made available to 506 the recommendation engine, which in turn selects or recommends content to be displayed.

Having now described an example implementation, a computing environment in which such a system is designed to operate will now be described. The following description is intended to provide a brief, general description of a suitable computing environment in which this system can be implemented. The system can be implemented with numerous general purpose or special purpose computing hardware configurations. Examples of well-known computing devices that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

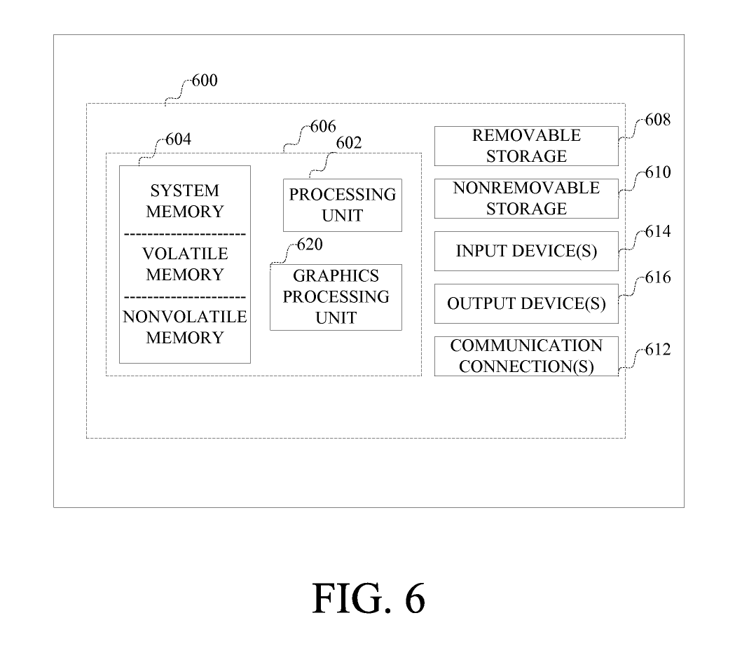

FIG. 6 illustrates an example of a suitable computing system environment. The computing system environment is only one example of a suitable computing environment and is not intended to suggest any limitation as to the scope of use or functionality of such a computing environment. Neither should the computing environment be interpreted as having any dependency or requirement relating to any one or combination of components illustrated in the example operating environment.

With reference to FIG. 6, an example computing environment includes a computing machine, such as computing machine 600. In its most basic configuration, computing machine 600 typically includes at least one processing unit 602 and memory 604. The computing device may include multiple processing units and/or additional co-processing units such as graphics processing unit 620. Depending on the exact configuration and type of computing device, memory 604 may be volatile (such as RAM), non-volatile (such as ROM, flash memory, etc.) or some combination of the two. This most basic configuration is illustrated in FIG. 6 by dashed line 606. Additionally, computing machine 600 may also have additional features/functionality. For example, computing machine 600 may also include additional storage (removable and/or non-removable) including, but not limited to, magnetic or optical disks or tape. Such additional storage is illustrated in FIG. 6 by removable storage 608 and non-removable storage 610. Computer storage media includes volatile and nonvolatile, removable and non-removable media implemented in any method or technology for storage of information such as computer program instructions, data structures, program modules or other data. Memory 604, removable storage 608 and on-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine 600. Any such computer storage media may be part of computing machine 600.

Computing machine 600 may also contain communications connection(s) 612 that allow the device to communicate with other devices. Communications connection(s) 612 is an example of communication media. Communication media typically carries computer program instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media.

Computing machine 600 may have various input device(s) 614 such as a keyboard, mouse, pen, camera, touch input device, and so on. Output device(s) 616 such as a display, speakers, a printer, and so on may also be included. All of these devices are well known in the art and need not be discussed at length here.

Such a system may be implemented in the general context of software, including computer-executable instructions and/or computer-interpreted instructions, such as program modules, being processed by a computing machine. Generally, program modules include routines, programs, objects, components, data structures, and so on, that, when processed by a processing unit, instruct the processing unit to perform particular tasks or implement particular abstract data types. This system may be practiced in distributed computing environments where tasks are performed by remote (processing, devices that are linked through a communications network. In a distributed computing environment, program modules may be located in both local and remote computer storage media including memory storage devices.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process comprising:
on a client computer:
receiving, into memory, data describing a page to be displayed, wherein the page includes a plurality of objects;
rendering the page for a display area having a size;
determining, for each object of the page, visibility of the object in the display area by comparing position and size of the object in the page to size and position of the page in the display area; and
reporting the visibility of the objects on the page to a server computer;
on the server computer:
storing the visibility of the objects on the page in a database.

2. The computer-implemented process of claim 1, further comprising:
tracking manipulation of the objects in the display area; and
reporting the manipulation of the objects to the server.

3. The computer-implemented process of claim 1, wherein reporting comprises sending data over a computer network to a business intelligence engine on the server computer.

4. The computer-implemented process of claim 1, wherein determining visibility of an object comprises determining if the object is visible, partially visible or not visible.

5. The computer-implemented process of claim 4, wherein determining visibility of an object further comprises determining visibility of subobjects of each object.

6. The computer-implemented process of claim 1, wherein reporting visibility of objects on a page comprises, after rendering an object, triggering an event to a business intelligence engine, wherein the event includes data describing object identifiers, page identifiers and visibility information of the objects on the page.

7. An article of manufacture, comprising:
a computer readable storage medium;
computer program instruction stored on the computer readable storage medium that, when processed by a computer, instruct the computer to perform a process, comprising:
receiving, into memory, data describing a page to be displayed, wherein the page includes a plurality of objects;
rendering the page for a display area having a size and determining, for each object of the page, visibility of the object in the display area by comparing position and size of the object in the page to size and position of the page in the display area; and
reporting the visibility of the objects on the page to a server computer for storage in a database.

8. The article of manufacture of claim 7, wherein the process further comprises:
tracking manipulation of the objects in the display area; and
reporting the manipulation of the objects to the server computer for storage in the database.

9. The article of manufacture of claim 7, wherein reporting comprises sending data over a computer network to a business intelligence engine on the server computer.

10. The article of manufacture of claim 7, wherein determining visibility of an object comprises determining if the object is visible, partially visible or not visible.

11. The article of manufacture of claim 7, wherein determining visibility of an object further comprises determining visibility of subobjects of each object.

12. The article of manufacture of claim 7, wherein reporting visibility of objects on a page comprises, after rendering an object, triggering an event to a business intelligence engine, wherein the event includes data describing object identifiers, page identifiers and visibility information of the objects on the page.

13. A computer-implemented process comprising:
transmitting, over a period of time, to a plurality of client computers, a page comprising a plurality of objects for display in display areas on the client computers;
receiving, into memory, from the plurality of client computers, data describing visibility of the objects from the page in the display areas on the client computers; and
compiling, in storage, the data describing the visibility of the objects from the page as displayed on the client computers over the period of time.

14. The computer-implemented process of claim 13, further comprising:
receiving, into memory, data describing actions associated with objects from the page in the display area displayed to the user;
compiling, in the storage, the data describing the actions with the data describing the visibility of the objects.

15. The computer-implemented process of claim 14, wherein receiving comprises receiving the data for a plurality of users.

16. The computer-implemented process of claim 13, wherein data describing visibility of objects includes data describing visibility of subobjects of an object.

17. The computer-implemented process of claim 13, wherein receiving visibility of objects on a page comprises, after rendering of objects on a page, receiving an event from an application rendering the object, wherein the event includes data describing object identifiers, page identifiers and visibility information of the objects on the page.

18. The computer-implemented process of claim 13, wherein each client computer determines, for each object of the page, visibility of the object in the display area by comparing position and size of the object in the page to size and position of the page in the display area.

19. The computer-implemented process of claim 1, wherein the server compute receives and stores visibility data for the page from a plurality of client computers over a period of time.

20. The article of manufacture of claim 7, wherein the server computer receives and stores visibility data for the page from a plurality of client computers over a period of time.
